(19) United States
(12) Patent Application Publication
(10) Pub. No.: US 2005/0223763 A1
(43) Pub. Date: Oct. 13, 2005

(54) Returning device for lock

(76) Inventors: Lan-Shi Huang, Kaohsiung (TW); Kuang-Chun Chiang, Kaohsiung Hsien (TW)

Correspondence Address: BIRCH STEWART KOLASCH & BIRCH, PO BOX 747, FALLS CHURCH, VA, 22040-0747, US

(21) Appl. No.: 10/820,116

(22) Filed: Apr. 8, 2004

(51) Int. Cl. E05B 13/10

(52) U.S. Cl. 70/224

(57) ABSTRACT

A lock includes a rose having two positioning plates on a side thereof, a handle rotatably extending through the rose, a spindle including a first end securely attached to the handle, and a return disc mounted to a second end of the spindle. The return disc includes an annular wall and a notch. A return spring is received in the annular wall and extends through the notch of the return disc, with two ends of the return spring being respectively attached to the positioning plates of the rose for returning the handle. Since the return spring is directly received in the annular wall of the return disc, a compact design is provided.

### BACKGROUND OF THE INVENTION

1. Field of the Invention

The present invention relates to a returning device for a lock. In particular, the present invention relates to a return spring that is directly received in a return disc of a lock.

2. Description of Related Art

A typical conventional lock comprises a handle, a spindle having an end securely attached to the handle to turn therewith, a return disc mounted around the other end of the spindle, and a return spring mounted around the return disc for returning the handle and the spindle. The return spring has two ends that are respectively attached to a rose through which the handle is rotatably extended. However, mounting of the return spring around the return disc is not easy and fails to provide a compact design. The present invention is intended to provide an improved lock to solve these problems.

### OBJECTS OF THE INVENTION

An object of the present invention is to provide a lock with a simplified structure.

Another object of the present invention is to provide a lock with a compact design.

A further object of the present invention is to provide a lock with improved structural strength.

### SUMMARY OF THE INVENTION

In accordance with an aspect of the present invention, a lock comprises a rose including two positioning plates on a side thereof, a handle rotatably extending through the rose, a spindle including a first end securely attached to the handle, and a return disc mounted to a second end of the spindle. The return disc includes an annular wall and a notch. A return spring is received in the annular wall and extends through the notch of the return disc, with two ends of the return spring being respectively attached to the positioning plates of the rose for returning the handle. Since the return spring is directly received in the annular wall of the return disc, a compact design is provided.

In an embodiment of the invention, the return disc includes a flange, and the rose includes a stepped portion for engaging with the flange of the return disc, providing improved structural strength of the lock.

The return spring may be coaxially received in the annular wall of the return disc.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a lock in accordance with the present invention;

FIG. 2 is a sectional view of the lock in accordance with the present invention, wherein the lock is in an unlocked state;

FIG. 3 is a sectional view taken along plane 3-3 in FIG. 2;

FIG. 4 is a sectional view similar to FIG. 3, illustrating turning of a handle of the lock in an unlocked state;

FIG. 5 is a sectional view similar to FIG. 2, wherein the lock is in a locked state;

FIG. 6 is an exploded perspective view of a modified embodiment of the lock in accordance with the present invention; and

FIG. 7 is a sectional view of the lock in FIG. 6.

### DETAILED DESCRIPTION OF THE PREFERRED EMBODIMENTS

Preferred embodiments of the present invention are now to be described hereinafter in detail.

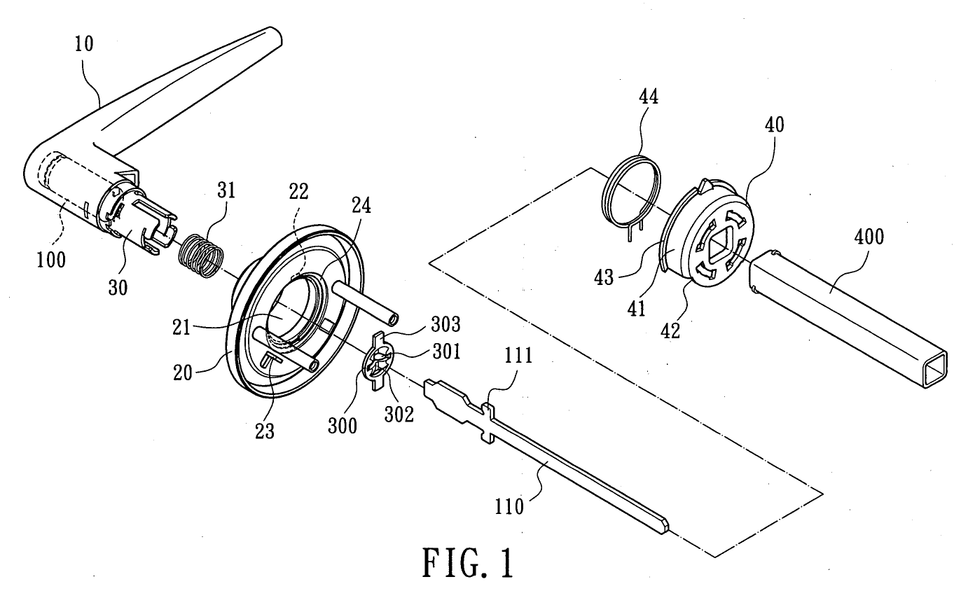

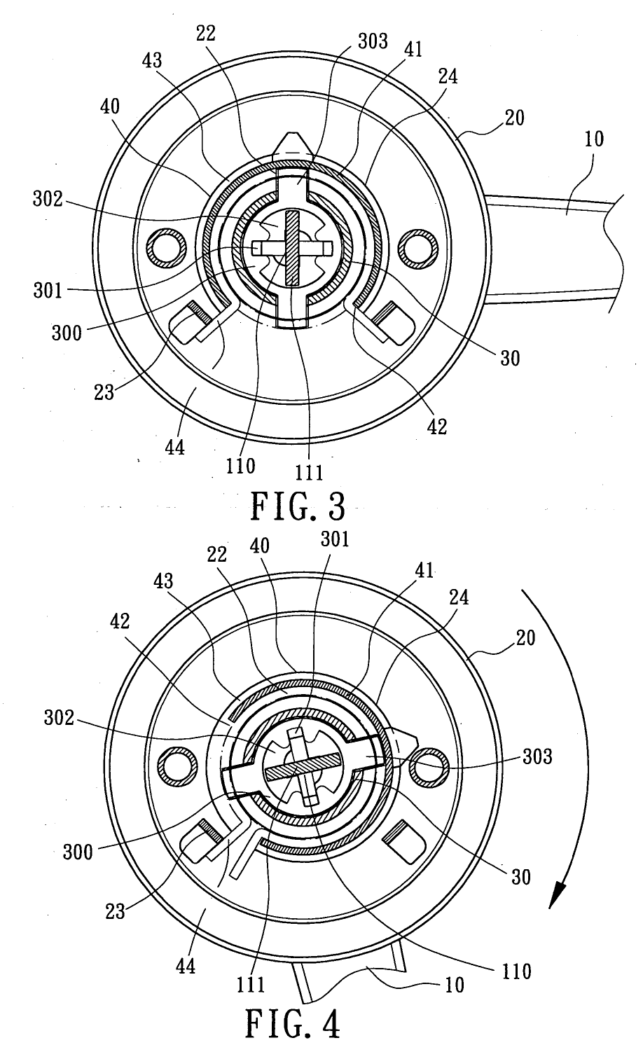

Referring to FIGS. 1 through 3, a lock in accordance with the present invention comprises a handle (an outer handle 10 in this embodiment), a lock core assembly 100, a locking/unlocking bar 110, a rose 20, a spindle 30, and a return disc 40. The lock core assembly 100 is mounted to the outer handle 10 to form an integral unit that is mounted by the rose 20 to a side of a door (not shown). An end of the spindle 30 is securely received in the outer handle 10, and the return disc 40 is mounted on the other end of the spindle 30.

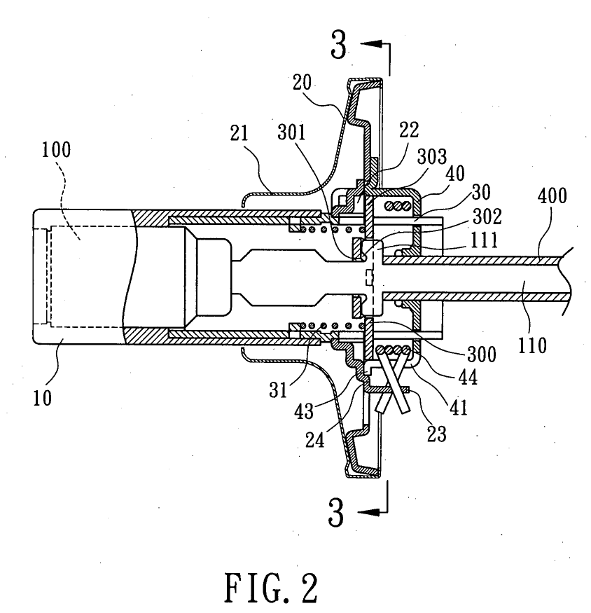

As illustrated in FIGS. 1 and 2, the locking/unlocking bar 110 is an elongated member having an end coupled to the lock core assembly 100. Further, the locking/unlocking bar 110 is rotatably extended through the spindle 30, a restraining plate 300, the return disc 40, and an actuating member 400, as shown in FIG. 2. The locking/unlocking bar 110 includes at least one lobe 111 (two in this embodiment).

Still referring to FIG. 1, the rose 20 includes a neck 21 on a side thereof. Formed on the other side of the rose 20 are at least one positioning groove 22 (two in this embodiment), at least two positioning plates 23, and a stepped portion 24. In assembly, the neck 21 of the rose 20 is engaged with the outer handle 10 after the lock core assembly 100 and the spindle 30 have been mounted to the outer handle 10.

Still referring to FIGS. 1 and 2, the spindle 30 is a tubular member that receives a spring 31 for biasing the restraining plate 300. The restraining plate 300 is an integrally formed metal plate including an elongated hole 301, at least one V-shaped groove 302 (two in this embodiment), and at least one engaging piece 303 (two in this embodiment). Further, the spindle 30 is engaged with the return disc 40 to prevent disengagement of the spring 31 and the restraining plate 300. In this case, the spring 31 is in a compressed state to bias the restraining plate 300, thereby controlling the position of the engaging piece 303, which will be described later.

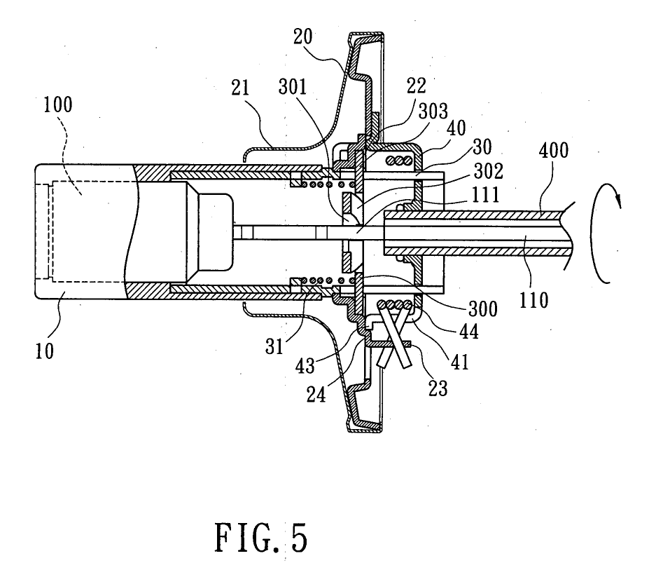

Referring to FIG. 5, when in a locked state, the engaging pieces 303 of the restraining plate 300 are respectively received in and thus restrained by the restraining grooves 22 of the rose 20 to thereby prohibit rotational movement of the outer handle 10. Thus, the outer handle 10 cannot be turned. When a key (not shown) is used to turn the lock core assembly 100 in an unlocking direction, the locking/unlocking bar 110 is turned. The lobes 111 of the locking/unlocking bar 111 actuate the restraining plate 300 to move axially such that the engaging pieces 303 are disengaged from the positioning grooves 22 of the rose 20, as shown in FIG. 2. In this unlocking state, the outer handle 10 can be turned. The user may turn the key in the opposite direction (locking direction) to turn the locking/unlocking bar 110 in an opposite direction to thereby axially move the restraining plate 300 in the opposite direction until the engaging pieces 303 of the restraining plate 300 are engaged in the positioning grooves 22 of the rose 20, as shown in FIG. 5. The structure and operation of restraining plate 300 are conventional and therefore not described in detail.

Referring to FIGS. 1 through 3, the return disc 40 is an integral member including an annular wall 41, a notch 42, and a flange 43. A return spring 44 is mounted in the return disc 40. More specifically, the return spring 44 is coaxially received in the annular wall 41 to reduce the space occupied by the lock, thereby providing a compact design. Two ends of the return spring 44 are extended through the notch 42 of the return disc 40 and respectively attached to the positioning plates 23 of the rose 20 for returning the outer handle 10. More specifically, when the outer handle 10 is turned, the return spring 44 is overcome and the spindle 30 and the return disc 40 are turned, as shown in FIG. 4. When the outer handle 10 is released, the outer handle 10, the spindle 30, and the return disc 40 are returned to their original position under the action of the return spring 44. Since the return spring 44 is directly received in the return disc 40, the assembling procedure is simple and the lock is thus compact.

As illustrated in FIGS. 1 and 2, an end of the actuating member 400 is extended through the return disc 40 to allow joint rotation of the actuating member 400 and the return disc 40. The other end of the actuating member 400 is coupled to a latch assembly (not shown) such that rotation of the outer handle 10 causes retraction of a latch bolt (not shown) of the latch assembly when the lock is in an unlocked state.

As illustrated in FIG. 2, to strengthen the engagement between the rose 20 and the return disc 40, the stepped portion 24 of the rose 20 is engaged with the flange 43 of the return disc 40. Thus, in addition to the engagement among the outer handle 10, the spindle 30, and the return disc 40, the structure of the lock is further strengthened by the engagement between the stepped portion 24 of the rose 20 and the flange 43 of the return disc 40.

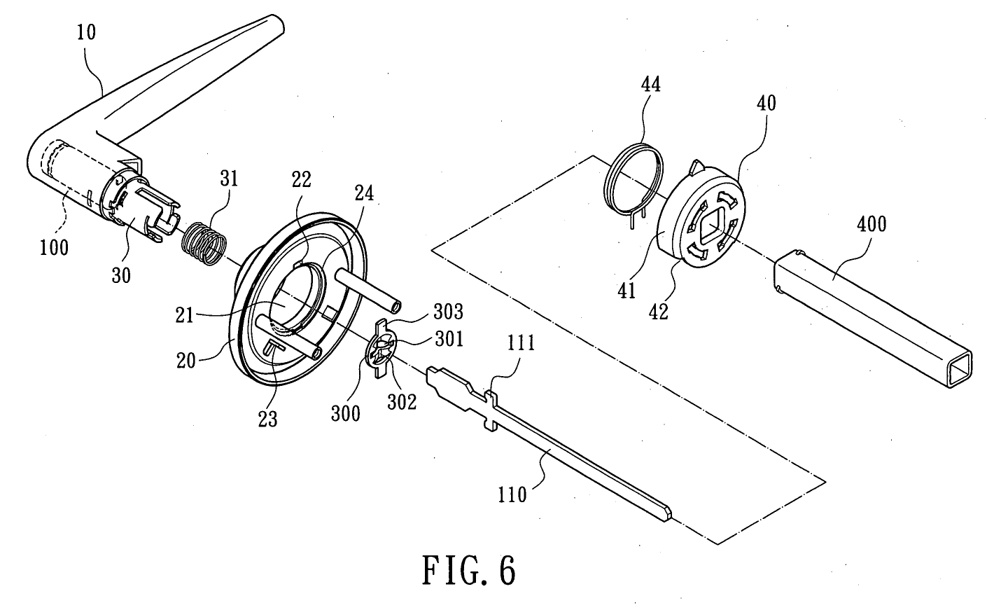

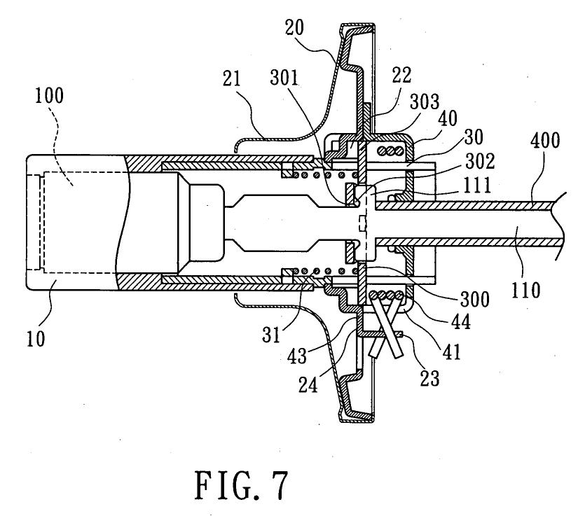

FIGS. 6 and 7 illustrate a modified embodiment of the lock in accordance with the present invention. In this embodiment, the flange 43 of the return disc 40 and the stepped portion 24 of the rose 20 in the above embodiment are omitted to provide a simplified structure.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

1. A lock comprising:
a rose including a first side and a second side, two positioning plates being provided on the second side of the rose;
a handle rotatably extending through the rose;
a spindle including a first end securely attached to the handle and a second end; and
a return disc mounted to the second end of the spindle, the return disc including an annular wall and a notch, a return spring being received in the annular wall and extending through the notch of the return disc, with two ends of the return spring being respectively attached to the positioning plates of the rose for returning the handle.

2. The lock as claimed in claim 1, wherein the return disc includes a flange, and wherein the rose includes a stepped portion for engaging with the flange of the return disc.

3. The lock as claimed in claim 1, wherein the first side of the rose includes a neck, the handle being rotatably extended through the neck, the second side of the rose including at least one positioning groove, a restraining plate and a spring being mounted in the spindle, the restraining plate being slidable along an axial direction of the spindle, the restraining plate including at least one engaging piece that is releasably engaged in said at least one positioning groove of the rose for prohibiting rotation of the handle.

4. The lock as claimed in claim 3, further including a lock core assembly and a locking/unlocking bar mounted to the handle, the locking/unlocking bar being rotatably extended through the spindle, the restraining plate, and the return disc, the restraining plate including at least one V-shaped groove for cooperating with the locking/unlocking bar to control axial position of the restraining plate.

5. The lock as claimed in claim 4, wherein the locking/unlocking bar includes at least one lobe for cooperating with said at least one V-shaped groove to control axial position of the restraining plate.

6. The lock as claimed in claim 1, further including an actuating member including a first end securely connected to the return disc and a second end connected to a latch assembly.

7. The lock as claimed in claim 4, wherein the restraining plate includes an elongated hole through which the locking/unlocking bar extends.

8. The lock as claimed in claim 1, wherein the return spring is coaxially received in the annular wall of the return disc.
